(19) United States
(12) Patent Application Publication
(10) Pub. No.: US 2007/0157779 A1
(43) Pub. Date: Jul. 12, 2007

(54) ROD-CUTTING DEVICE AND ROD MATERIAL CONVEYOR DEVICE OF THE TOBACCO-PROCESSING INDUSTRY

(75) Inventors: Gerd Strohecker, Marschacht (DE); Soenke Horn, Geesthacht (DE); Joachim Glogasa, Geesthacht (DE); Jan Peisker, Schulendorf (DE); Michael Lueneburg, Geesthacht (DE)

Correspondence Address: GREENBLUM & BERNSTEIN, P.L.C., 1950 ROLAND CLARKE PLACE, RESTON, VA, 20191, US

(73) Assignee: HAUNI MASCHINENBAU AG, Hamburg (DE)

(21) Appl. No.: 11/613,436

(22) Filed: Dec. 20, 2006

(30) Foreign Application Priority Data
Dec. 23, 2005 (DE) 10 2005 062 644.0

(51) Int. Cl. B26D 7/06

(52) U.S. Cl. 83/78

(57) ABSTRACT

A rod-cutting device and method of the tobacco-processing industry. The device includes a rotatable cutting body with a cutting edge, and a first rotary body with a rotation axis on which the cutting body is arranged. The cutting body is arranged essentially parallel to the rotation axis of the first rotary body, and has an extension at least from a mounting point to the cutting edge. A tangent of the first rotary body extends through or parallel to the extension.

### CROSS-REFERENCE TO RELATED APPLICATIONS

The present application claims priority under 35 U.S.C. § 119 of German Patent Application No. 10 2005 062 644.0 filed Dec. 23, 2005, the disclosure of which is expressly incorporated by reference herein in its entirety.

### BACKGROUND OF THE INVENTION

1. Field of the Invention

The invention relates to a rod-cutting device of the tobacco-processing industry with a cutting body moved in a rotating manner with a cutting edge. The cutting body is arranged on a first rotary body with a rotation axis. The invention further relates to a device for conveying away rod material for a rod maker (rod-making machine) of the tobacco-processing industry. Moreover, the invention relates to a method for operating a rod maker of the tobacco-processing industry.

2. Discussion of Background Information

With a rod maker of the tobacco-processing industry, upon startup the speed of conveying the rod produced must reach a standard range in order to achieve desired properties of the rod, such as strength, durability of a wrapping material seam and more, in order to feed the rod to a standard further processing. When the corresponding properties of the rod have been achieved, a cut, a break or a severing of the rod is performed and the rod material produced before the cut, the break or the severing is carried away and the rod following it is fed to the standard further processing.

This is generally achieved in that upon restarting a rod maker until a standard speed has been reached and the other desired properties of the rod have been achieved, the rod produced is guided on a different track from the rod that is to be used for further processing.

To this end guide elements can be provided, such as is described, e.g., in EP 0 286 828 B1. The section of the rod that was produced before the standard speed and before the properties of the rod had been achieved is cut into small pieces with a type of shredder and either discarded or conveyed away for raw material recovery. With this method, the transition from a first conveyor direction, in which the material is conveyed away, to a second conveyor direction, in which the rod is conveyed for proper further use, is critical. In particular the separation of the two rod sections is critical. DE 38 13 786 C2 describes a corresponding separating device that works well.

It can also happen in the operation of a rod maker that, due to a fault, the rod bursts after leaving a garniture device in which the rod is formed and in which, e.g., a wrapping material strip is wound around it and closed at an adhesive-coated seam, so that the area downstream of the garniture device can clog very quickly. This material then has to be removed manually.

### SUMMARY OF THE INVENTION

The present invention develops components of a rod maker of the tobacco-processing industry, which components are to be used for a reliable operation of the rod maker. In particular, a cutting device is to be disclosed, by which a rod can be cut or severed efficiently and reliably such that a section of the rod can be fed to further processing after cutting. Furthermore, a device for conveying away rod material is to be disclosed, by which it is possible to restart a rod maker and, in the event of a fault occurring in the rod maker, the rod material not provided for further processing can be conveyed away efficiently. Furthermore, a reliable method for operating a rod maker of the tobacco-processing industry is to be disclosed.

According to invention, a rod-cutting device of the tobacco-processing industry includes a cutting body, moved in a rotating manner, with a cutting edge. In this way, the cutting body is arranged on a first rotary body with a rotation axis, whereby the cutting body is arranged essentially parallel to the rotation axis of the first rotary body, and whereby the cutting body has an extension at least from one mounting point to a cutting edge, whereby a tangent of the first rotary body or a parallel thereto extends through the extension.

A very efficient and precise cut can be made through a rod of the tobacco-processing industry through the arrangement of the cutting body essentially parallel to the rotation axis of a first rotary body. Within the scope of this invention, the first rotary body is to be understood in particular to be a rotating body that can exhibit a rotational symmetry, but does not need to do so. Thus, for example, a partial cylinder can be provided, or a cone or a partial cone or simply merely an arm, on the outer end of which the cutting body is arranged tangentially or parallel thereto or essentially parallel to the rotation axis of the first rotary body, thus, e.g., not fully at the end of the arm, but displaced radially thereto. In this regard, tangentially arranged or parallel to the tangential arrangement means in particular a tangent actually predominating on the first rotary body or a tangent that can bear against a circle produced by rotation.

The tangent or the parallel to the tangent thus preferably runs through a mounting point of the cutting body to a cutting edge or, however, a parallel to the tangent runs through the extension of the cutting body. An embodiment is particularly preferred in which the cutting body projects beyond the first rotary body at least in part in the longitudinal axial direction of the rotation axis. The cutting edge is thereby spaced apart from the first rotary body or spaced with respect to the rotary body, e.g., below or above the first rotary body seen relative to the axial direction of the rotation axis. The cutting edge is preferably moved perpendicular to the rotation axis during the rotation of the first rotary body. The cutting body and the cutting edge preferably project beyond the area of the first rotary body, which area is adjacent to the circumferential surface or adjoins the circumferential surface. The cutting body thus projects beyond the end surfaces of the first rotary body. Within the scope of the invention, rod-cutting device also means a rod-separating device or rod-severing device.

The cutting edge is preferably arranged essentially parallel to the rotation axis of the first rotary body. However, the cutting edge can also be arranged obliquely thereto or a slanted cutting edge can be provided. The cutting edge is arranged transversely, preferably perpendicular to the tangent or parallel thereto which runs through the extension of the cutting body.

If the rotation axis of the first rotary body is spaced apart from a longitudinal axis of a rod to be cut, thus is displaced with respect to the longitudinal axis, a cut can be achieved with minimal compression or no compression at all of a moving rod transverse to the movement direction of the rod.

The rotation axis of the first rotary body is preferably arranged at an angle to the longitudinal axis of a rod to be cut which is unequal 90°. The angle is to be measured or indicated between the rotation axis or a projection of the rotation axis on the longitudinal axis, since the rotation axis and the longitudinal axis do not necessarily have to intersect. The angle corresponds to an angle that results through a corresponding parallel displacement of the rotation axis or the longitudinal axis between the two axes. The angle between the rotation axis of the first rotary body and the longitudinal axis in the downstream part of the rod is preferably less than 90°. This angle can preferably be adjusted depending on the speed of the rod and in particular the distance of the rotation axis to the longitudinal axis, in order to render possible the cleanest possible cut without compression of the rod.

It is particularly preferred if a groove is provided for guiding a rod, which groove on the one hand ensures a clean cut and on the other hand ensures a good guidance of the rod. The groove extends in a longitudinal axial manner to the rod or can also define the longitudinal axis of the rod at least in the area of the cutting device.

Furthermore, a circle segment-shaped groove or opening is preferably provided which renders possible a passage movement of the part of the cutting body projecting beyond the first rotary body.

The invention is directed to a rod-cutting device of the tobacco-processing industry with a cutting body moved in a rotating manner. The body has a knife, and the cutting edge of the knife is arranged parallel to the rotation axis of the cutting body. The cutting edge is preferably at least twice the length of the diameter of the rod to be cut or severed. The knife preferably extends perpendicular to the rotation axis over the cutting body. Very precise cuts can be made through this. The cutting body is preferably a rotary body or a part of a rotary body.

The rod-cutting device is particularly efficient if a cutter roller is provided which interacts with the cutting body. To this end a groove is preferably provided in the cutter roller, into which groove the knife plunges intermittently during operation. The cutting body and/or the cutter roller preferably has a cut-out or a flat spot. Within the scope of the invention, a cut-out is in particular an incision in the rotary body extending over a certain length parallel to the rotation axis, so that a free space in the rotary body is produced there. Within the scope of the invention, a flat spot is in particular a rotary body from which material has been removed. In the case of a cylindrical rotary body, e.g., a cylinder section is then removed. With a section through the rotary body, a partial circle segment would then be removed.

During operation the cut-out and/or the flat spot serve to leave sufficient space for the rod material so that, unobstructed, it can pass through or be conveyed by the rod-cutting device and in particular the cutting body and the cutter roller. This applies in operation when the rod formed is to be used for further processing, as well as during startup during which, e.g., the rod material is guided on another track.

If at least one compressed-air nozzle is provided which is embodied in order to direct compressed air against the rod during operation, the startup of rod production and the conversion of the rod conveyor device from startup into final production can be supported. For example, a compressed-air nozzle can hereby be provided which is arranged above the rod and is directed in the rod conveyor direction and slightly downward. Furthermore, a compressed-air nozzle can be provided that is arranged below the rod and compressed air is directed in the rod conveyor direction and slightly upward. Depending on the desired rod position, the upper or the lower or both compressed-air nozzles can be operated.

The invention is also directed to a rod-cutting device with a cutting body than can be moved in a rotating manner, with a cutting edge, whereby the cutting body can be moved about a rotation axis that lies crosswise to a rod that can be cut by the cutting body. In this way, the rotation axis is arranged essentially horizontally during operation of the rod-cutting device. The cutting body can preferably be moved about a rotation axis that lies essentially perpendicular to a rod that can be cut by the cutting body. Preferably the cutting body can be swung clear of the rod. Within the scope of the invention, can be swung clear of means in particular can be pivoted out of the working zone with the rod.

Preferably a rod guidance is provided that is arranged structurally with the cutting body so that they can be swung clear of the rod about a common pivot axis. The rod guidance and the cutting body are embodied, e.g., such that the rotation axis of the cutting body and a rod guide surface are essentially parallel to one another.

The pivot axis is preferably arranged essentially parallel to the produced rod. In contrast to DE 38 13 786 C2, the cutting body according to the invention is arranged perpendicular to the cutting body according to that in the cited document. The guide surface is arranged next to the cutting body and not, as in DE 38 13 786 C2 as it were incorporated in the cutting body.

Preferably, a back support is arranged upstream of the cutting device, which back support supports the cutting of the rod. The back support can be a type of pusher. The back support can be subjected to a slight leading when being moved to the rod so that it already has the back support position necessary for a severing cut when the cutting body acts on the rod with its cutting knife. In contrast to DE 38 13 786 C2, the back support is arranged in front of the cutting body in the conveyor direction of the rod and not behind it, as in the cited document.

The invention further provides a device for conveying away rod material for a rod maker of the tobacco-processing industry, such that two rotary bodies rotating in opposite directions are provided. In this manner, by the second rotary body rod material can be drawn in between the second rotary bodies and subsequently conveyed away, such that a gap forming between the second rotary bodies extends essentially in the conveyor direction of a rod during production operation. Within the scope of the invention, production operation means in particular the production or manufacture of a rod at the predetermined standard speed or of a proper rod that can be conveyed for further processing.

The second rotary bodies are preferably spaced slightly apart in order to be able to carry away sufficient rod material through the gap of the second rotary bodies. The direction of rotation of the second rotary bodies is such that the rotary component of the respective second rotary body at the closest point to the other second rotary body points in the same direction, namely away from the area from which rod material is to be carried away. Preferably the rotation axes of the second rotary bodies are essentially parallel. The second rotary bodies are preferably cylindrical. However, they can also be conical or have respectively one arm or several arms. The second rotary bodies can also be star-shaped in cross section or represent a geometric figure that is not circular in cross section. In the case of a conical or frusto-conical shape, it can be expedient not to arrange the rotation axes of the second rotary bodies parallel, namely such that the tangential surfaces of the lines of the respective circumferential surface of the second rotary bodies are parallel to one another where they come closest to one another, so that in particular a straight slot is formed.

Preferably the rotation axes of the second rotary bodies are arranged crosswise to the conveyor direction of a rod. Within the scope of the invention, crosswise means that the gap is oriented at an angle of >0° to 40° away from the rod, whereby the rod and the gap are arranged in one plane. The slot or gap formed by the second rotary bodies forms a line that preferably has a component that is arranged parallel to the conveyor direction of the rod.

Preferably the second rotary bodies are pressure-loaded or force-loaded with respect to one another. Through this different quantities of filter material can be conveyed away easily. Preferably, a first of the second rotary bodies is spring-loaded with respect to a second of the second rotary bodies. Within the scope of the invention, spring-loaded means that the first second rotary body is preloaded with a spring such that the first of the second rotary bodies presses against the second of the second rotary bodies. To this end the first second rotary body is embodied to be moveable in the transverse axial direction. Preferably both second rotary bodies are preloaded with springs and both accordingly moveable in the transverse axial direction.

Preferably, a second rotary body is a transport roller and particularly preferably both second rotary bodies are respectively transport rollers. Instead of transport rollers, cones, levers, single-armed, double-armed, three-armed to n-armed (when n is an integer) rotary bodies or devices can also be provided which are suitable for transporting material. The arms may be integral with the rotary bodies. In the event that the second rotary bodies are not rotary bodies in the mathematical sense, but rotating bodies with arms that extend radially, it can be provided that the two second rotary bodies interact such that the arms interact with one another on the circumferential surface or the external surface. However, the arms can also mesh with one another if, e.g., the filter material is also to be shredded at the same time as being conveyed away. The second rotary bodies can also be embodied, e.g., in a star-shaped manner. Preferably, the rotary bodies are embodied symmetrically. In the case of the second rotary bodies recesses and elevations that improve the functionality of the transport can also be provided in the circumference or in the circumferential surface.

Preferably, if a rod material guide device is provided upstream or in the area of the second rotary bodies, it is ensured that the rod material can also be conveyed away completely. A rod material guide device can be, e.g., a cover that deflects the material in a desired direction.

The invention is directed to a device for conveying away rod material that includes a first lever device and a second lever device, such that one lever device can be moved relative to the other lever device in a translational manner. In particular, a translational linear movement relative to one another is provided. Preferably, the first and the second lever device can be pivoted about a common pivot axis that is, in particular, essentially parallel to a rod conveyor direction. In this case the device for conveying away rod material can be swung into the working zone with a rod or with a rod piece that is to be conveyed away in order subsequently with a translational, in particular, linear movement a lever device subsequently to grip the rod and, e.g., to pull it out of areas in which the rod is still stuck. After the release of the rod, it can then, e.g., be carried away into a container. In this respect, reference is made in particular to the description of the figures for FIGS. 5 through 7.

The second lever device preferably has two arms. In particular, the first lever device is preferably arranged at least partially between the arms of the second lever device. If the first and/or the second lever device include a roll that can be brought into engagement with the rod material, this rod material can be pulled very reliably out of openings in which the rod can still be stuck, without tearing or being broken first. Through this arrangement, it is very easily possible to automate the conveying away of the rod material.

According to the invention, a rod maker of the tobacco-processing industry is provided with a cutting device, which has been described above, and/or a device for conveying away rod material, which has also been described above.

The invention is directed to a method for operating a rod maker of the tobacco-processing industry, such that the production of a rod a rod is first formed and conveyed and, in the event that production is interrupted, e.g., where the interruption is triggered by an operator or a sensor, the material remaining in the rod maker is automatically removed from the rod maker and subsequently production is started anew. Through this procedure, rod production can be started again efficiently and automatically in the event of an interruption in production, whereby defective production of rod material is avoided. Preferably, after the start of the production the startup wastage is separated and subsequently the rod is fed to the further processing steps. Subsequently, feeding the rod to the further processing steps means in particular the accepted stock production, that is a rod with predetermined properties and/or a rod that has reached a desired speed. In the event that the rod opens, the rod material is preferably conveyed away over two second rotary bodies, whereby the second rotary bodies convey the rod material in a gap forming between the second rotary bodies. The rotary bodies turn or rotate in order to convey the rod material away in a correspondingly efficient manner.

The removal of the rod material preferably takes place by way of lever devices by which the rod material is gathered and moved and subsequently released again. Hereby, in particular rod material is pulled out of openings, which would otherwise lead to defective production upon startup of production.

The invention is also directed to a method for operating a rod maker of the tobacco-processing industry. Rod material is conveyed away between a gap forming through two second rotary bodies, such that, upstream of the second rotary bodies, a rod is formed and, after formation, is cut upstream of the second rotary bodies as soon as a rod with predetermined properties has been produced or a desired speed has been reached. In this manner, the section of the rod downstream relative to the cutting site is conveyed away and the part of the rod upstream relative to the cutting site is guided past the second rotary bodies for further processing. This method is particularly suitable for restarting or starting up a corresponding rod maker of the tobacco-processing industry.

The rotational speed of the second rotary bodies is preferably at least at times greater than the conveyor speed of the rod during the production of the rod. The rod material is thus conveyed away somewhat faster than the rod is formed. The rotational speed of the second rotary bodies is preferably greater than the speed of a garniture belt in which the rod is formed. The higher speed is preferably provided as long as at least one predetermined property of the rod is not present or until a predetermined rod conveyor speed has been achieved. After a predetermined rod conveyor speed has been reached or after the desired properties have been achieved, the speed of the second rotary bodies can be adjusted to the conveyor speed of the rod.

The instant invention is directed to a rod-cutting device of the tobacco-processing industry. The device includes a rotatable cutting body with a cutting edge, and a first rotary body with a rotation axis on which the cutting body is arranged. The cutting body is arranged essentially parallel to the rotation axis of the first rotary body, and has an extension at least from a mounting point to the cutting edge. A tangent of the first rotary body extends through or parallel to the extension.

According to a feature of the invention, at least a portion of the cutting body can project beyond the first rotary body in a longitudinal axial direction of the rotation axis.

In accordance with another feature of the invention, the cutting edge can be arranged essentially parallel to the rotation axis of the first rotary body.

According to still another feature of the present invention, the rotation axis of the first rotary body may be spaced apart from a longitudinal axis of a rod to be cut.

Further, the rotation axis of the first rotary body can be non-perpendicularly oriented at an angle to a longitudinal axis of a rod to be cut. The angle between the rotation axis of the first rotary body and the longitudinal axis may be less than 90° to a downstream part of the rod, relative to a rod travel direction.

Still further, a groove may be structured and arranged to guide a rod.

According to a still further feature of the instant invention, a circle segment-shaped groove or opening can be structured and arranged to enable movement of the at least a portion of the cutting body projecting beyond the first rotary body.

The present invention is directed to a rod-cutting device of the tobacco-processing industry. The device includes a cutting body rotatable around a rotation axis, and the cutting body having a knife. A cutting edge of the knife is arranged parallel to the rotation axis.

In accordance with the invention, the knife may be arranged to extend from the cutting body in a direction perpendicular to the rotation axis.

According to an aspect of the invention, the cutting body can include at least a part of a rotary body.

Moreover, a cutter roller can be structured and arranged to interact with the cutting body. The cutter roller may include a groove structured to intermittently receive the knife during operation. Further, at least one of the cutting body and the cutter roller can include one of a cut-out or flat portion.

According to another aspect of the invention, at least one compressed air nozzle can be arranged to direct compressed air against a rod during operation.

The present invention is directed to a rod-cutting device that includes a cutting body, movable in a rotating manner about a rotation axis, with a cutting edge. The rotation axis is oriented crosswise to a rod to be cut by the cutting body, and arranged essentially horizontally during operation of the rod cutting device.

In accordance with a feature of the present invention, the cutting body can be pivotable to be swung clear of the rod. Further, a rod guide may be pivotably arranged to be swung clear of the rod about a common pivot axis with the cutting body.

According to another feature of the invention, a back support can be arranged upstream of the cutting device, relative to a rod travel direction, to support a cutting of the rod.

The present invention is directed to a device for conveying away rod material for a rod maker of the tobacco-processing industry. The device includes two rotary bodies rotating in opposite directions and oriented to form a gap extending essentially in a rod travel direction. During production operation, the two rotary bodies are arranged to draw rod material into the gap in order to convey the rod material away.

According to an aspect of the instant invention, rotation axes of the two rotary bodies can be essentially parallel.

In accordance with another aspect of the invention, the rotation axes of the two rotary bodies may be arranged crosswise to the rod travel direction.

Further, the two rotary bodies may be pressure-loaded relative to one another. One of the two rotary bodies can be spring-loaded against an other of the two rotary bodies.

According to still another aspect of the present invention, at least one of the two rotary bodies may be a transport roller.

In accordance with a further aspect of the invention, a rod material guide device can be located at least one of upstream and in an area of the two rotary bodies.

The invention is directed to a device for conveying away rod material. The device includes a first lever device and a second lever device. One of the first and second lever device is movable in a translational manner relative to an other of the first and second lever device.

According to the invention, the first and the second lever devices can be pivotable about a common pivot axis that is essentially parallel to a rod conveyor device.

Moreover, the second lever device may include two arms. The first lever device can be arranged at least in part between the arms of the second lever device.

In accordance with another feature of the instant invention, at least one of the first and second lever devices can include a roll engagable with rod material.

The invention is directed to a rod maker of the tobacco-processing industry that includes the above-noted cutting device.

The present invention is directed to a rod maker of the tobacco-processing industry that includes the above-noted device for conveying away rod material.

The instant invention is directed to a method for operating a rod maker of the tobacco-processing industry. The method includes forming a rod and conveying the rod. Further, in an event of production interruption, the method includes automatically removing material remaining in the rod maker, and restarting the production process.

In accordance with an aspect of the invention, the production interruption can be initiated by one of an operator or a sensor.

According to another aspect of the invention, after the restart of the production process, the method can further include separating startup wastage and feeding to a further processing step.

According to a feature of the invention, when the production interruption includes an opening of the rod, the method can further include conveying the rod material away through a gap formed between two rotary bodies.

In accordance with another feature of the instant invention, the automatic removing of material remaining in the rod maker may be carried out by lever devices in order to gather, move and subsequently release the material.

Moreover, a method for operating a rod maker of the tobacco-processing industry can further include conveying the rod material away through a gap forming between two rotary bodies, forming a new rod upstream of the two rotary bodies, cutting the new rod upstream of the two rotary bodies as soon as at least one of the new rod exhibits predetermined properties and a desired production speed has been reached, conveying away a portion of new rod arranged downstream of the cutting, and guiding a portion of the new rod arranged upstream of the cutting past the two rotary bodies for further processing.

According to still yet another feature of the present invention, a rotational speed of the two rotary bodies can be at least at times greater than a conveyor speed of the new rod during the production of the new rod. Further, a greater speed can be provided to the two rotary bodies as long as at least one of a predetermined property of the new rod has not attained and a predetermined rod conveyor speed has been achieved.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates a three-dimensional representation of a part of a rod maker according to the invention of the tobacco-processing industry;

FIG. 2 diagrammatically illustrates a sectional representation of a part of the exemplary embodiment from FIG. 1 in side view;

FIG. 3 diagrammatically illustrates a cutting device according to the invention;

FIG. 4 diagrammatically illustrates a three-dimensional representation of the cutting device according to the invention depicted in FIG. 3;

FIG. 5 illustrates another embodiment of a rod maker according to the invention of the tobacco-processing industry in diagrammatic representation;

FIG. 6 illustrates a part of the embodiment depicted in FIG. 5 from a different perspective and in a different process condition in diagrammatic representation;

FIG. 7a illustrates a device for conveying away rod material according to the invention in diagrammatic side view in the swung clear position

FIG. 7b illustrates the device depicted in FIG. 7a in a position swung towards the rod;

FIG. 7c illustrates a diagrammatic plan view of the embodiment depicted in FIG. 7b;

FIG. 7d illustrates the device for conveying away rod material according to the invention in a step of the pulling out of rod material in diagrammatic side view; and

FIG. 7e diagrammatically illustrates a plan view of the device depicted in FIG. 7d.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the following Figs. respectively the same or same type of elements or corresponding parts are provided with the same reference numbers, so a corresponding repeated introduction has been omitted.

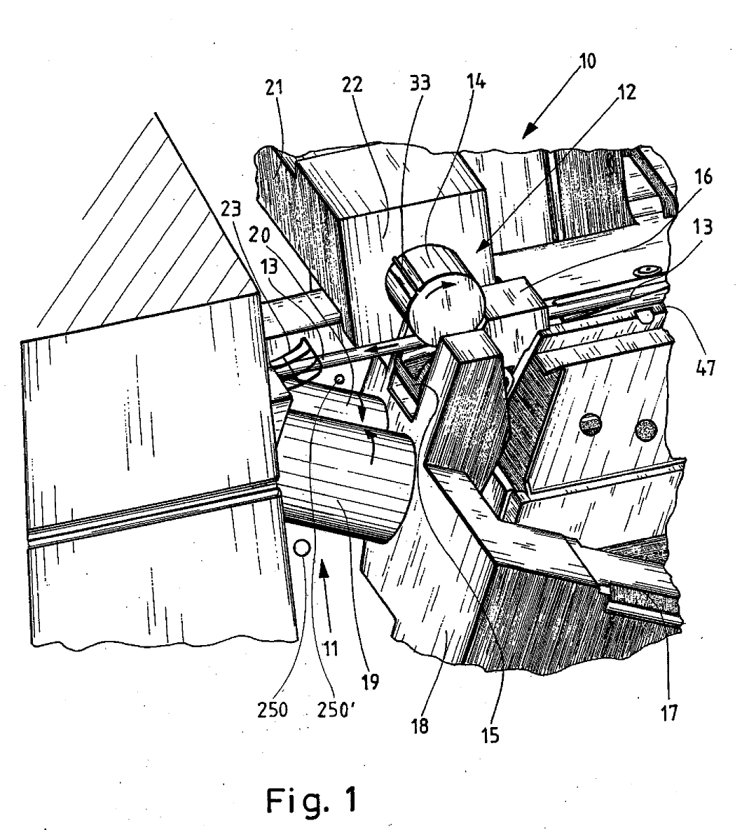

FIG. 1 shows a diagrammatic three-dimensional representation of a part of a rod maker 10 of the tobacco-processing industry according to the invention, whereby in this example a filter rod 13 is being produced. To this end, filter material as usual is placed on a wrapping material strip on a garniture belt and the wrapping material strip is wound around the filter material in the garniture. An adhesive-coated seam is closed to close the wrapping material strip The closed filter rod 13 is then guided through a transport nozzle 16 in the direction of a measuring element by which some properties of the filter rod are determined. Subsequently the filter rod is brought to a device for cutting to length in which the filter rod is cut into filter elements or filters of corresponding size in order subsequently to be joined to cut tobacco rods and to be further processed to form filter cigarettes.

During the startup of a filter rod maker 10 of the tobacco-processing industry, first the speed of the filter rod is increased to a standard speed. The rod produced before the standard speed has been reached does not generally have the desired properties, which is why this part of the filter rod is generally guided away as shown, e.g., in EP 0 286 828 B1. According to the invention an alternative conveying away of the filter material is now provided in which two second rotary bodies in the form of transport rollers 19 and 20 are provided in a device 11 for conveying away rod material. The corresponding rod material is forced down by a cover 23 in the direction of the transport roller 19 and 20 so that the transport rollers 19 and 20 gather rod material in the slot between the two transport rollers 19, 20 and convey it downwards through this slot in FIG. 1. In this case in which the rod is not shredded but is conveyed away in one piece, the conveyor speed through the transport rollers can be somewhat higher than the rod speed in the garniture 47.

After the standard speed has been reached in the rod production and the desired properties of the filter rod have also been achieved, by the knife roller 14 and the cutter roller 15, which can be moved synchronously, the rod is cut through the interaction of the two rollers 14 and 15 and in particular by the knife 33. The rod 13 is then conveyed for further processing as shown in FIG. 1. The cover 23 can be arranged at a fixed point. However, the cover 23 can also be provided to be moveable such that while the rod material is conveyed away by the device 11 for conveying away rod material, the cover 23 is arranged further in the direction of the transport rollers 19 and 20 and is moved somewhat higher so as not to block the way during the production of a correct rod 13 that is then conveyed for further processing. The transport rollers 19 and 20 are driven, e.g., via a servo motor 17 and a synchronous belt drive 18, namely in the arrow direction shown. The knife roller 14 is driven in the arrow direction shown by a servo motor 21 and a spur-gear stage 22. The cutter roller 15 is also driven accordingly.

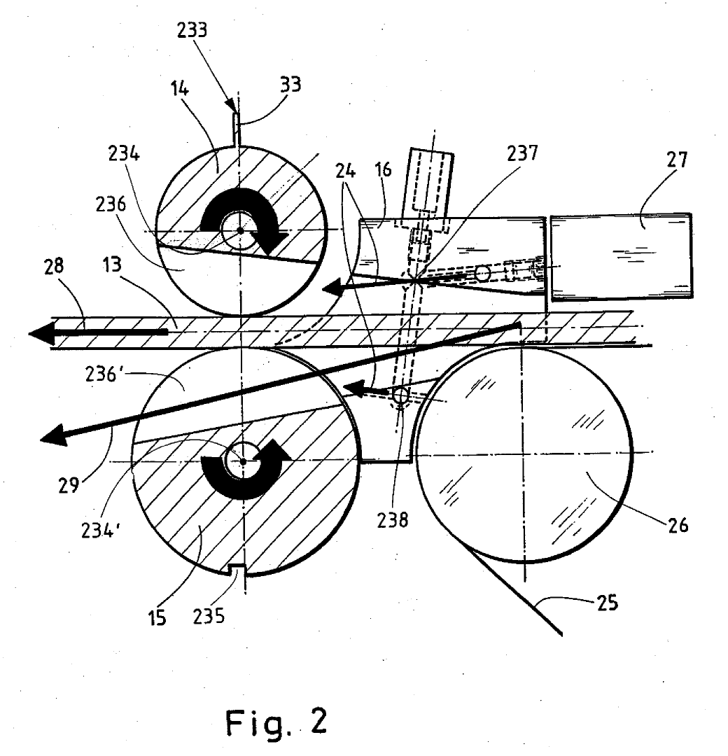

The cutting device 12 indicated in FIG. 1 is shown more clearly in FIG. 2 in a diagrammatic sectional representation.

A burst rod can furthermore occur in the operation of the rod maker 10 according to the invention so that due to the length of the signal registration after the burst rod has been detected approx. 3 m to 5 m rod is produced that can fill the space between a measuring nozzle and the garniture belt in an uncontrolled manner. For this reason it is expedient to have the transport rollers 19 and 20 running or rotating permanently in order to transport the rod material away in a targeted manner and to prevent clogging.

A burst rod can be detected, e.g., by an operator who then initiates a production stoppage. Alternatively, a sensor 250′ can be provided in the area between the position of the rod 13 during orderly production and the transport rollers 19 and 20. This sensor can detect a burst rod relatively quickly. For example, a photoelectric beam can be used to this end. Alternatively, a sensor 250 can be arranged below the transport rollers 19, 20. This sensor, which can also be a photoelectric beam, naturally reacts somewhat later than the sensor 250′ but still relatively promptly, since material is transported through the transport rollers 19, 20 relatively quickly in the event of a burst rod.

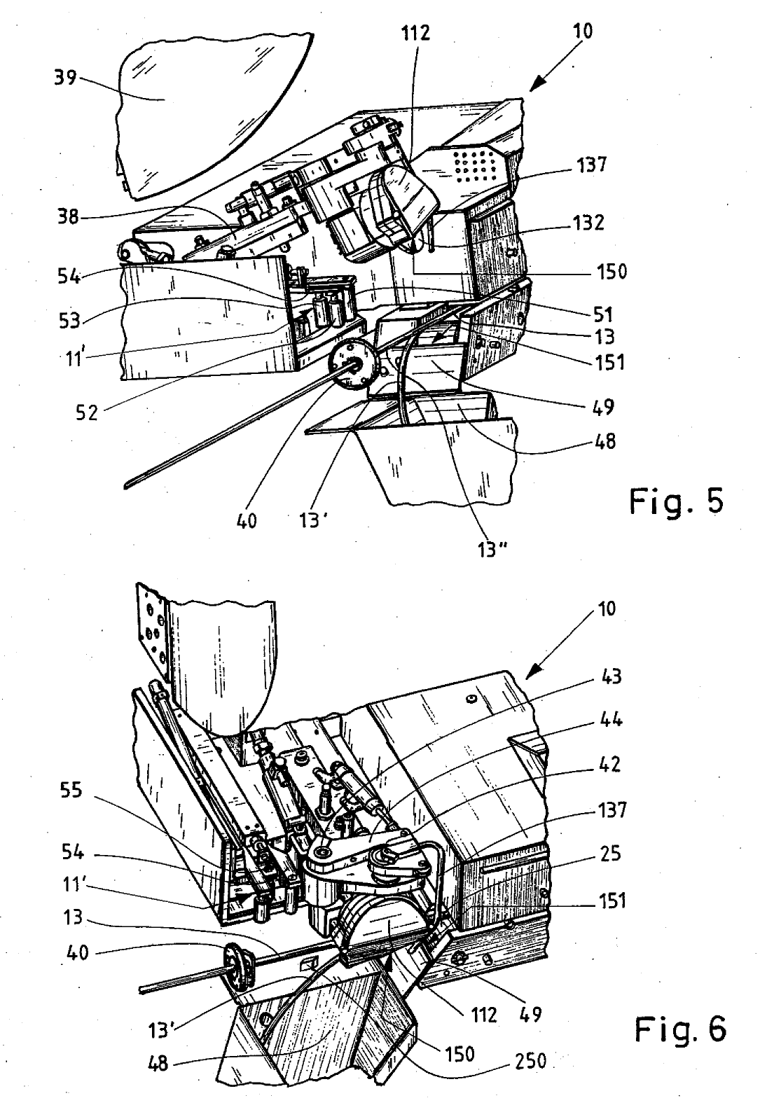

With a short-term burst rod, the rod bursts after leaving the cooling strip, which is shown, e.g., in FIG. 2 with reference number 27, and is transported further up to a measuring nozzle, which is shown, e.g., in FIGS. 5 and 6. The rod catches on the measuring nozzle and buckles. A cover 23 on the rod or over the rod forces the fold of the rod in the direction of the transport rollers 19 and 20. The transport roller 19 is preferably resilient so that even multilayer rod material can be transported away. The transport rollers gather the rod and convey it via a channel under the transport rollers 19, 20 out of the machine. The machine 10 can detect the burst rod via detectors 250, 250′ and is driven to a stop in a controlled manner. If the entire filter rod bursts, the burst rod is conveyed by transport nozzles and the rod cutter directly to the transport rollers 19, 20. The transport rollers gather the rod and convey it via a channel out of the machine. The machine also detects the burst rod via a detector and is driven to a stop in a controlled manner.

For an automated restart after a controlled stoppage, the garniture belt transports the rod until it buckles due to the lack of glue with a controlled stoppage and is drawn in by the transport rollers 19, 20. The transport rollers preferably run at a slight overspeed synchronous to the garniture belt. The rod speed is accelerated up to, e.g., 80 m/min. After the rod has been closed, the pair of rod cutter rollers or the cutting device 12 sever the rod. The cut rod is conveyed straight ahead into the measuring nozzle, according to the “operation” 28 rod conveyor direction from FIG. 2. The severed part of the rod 13 is conveyed away by the transport rollers 19 and 20 through a channel of the machine.

In the case of an automatic restart after an uncontrolled stoppage, the rod has already been drawn between the traction rollers 19, 20. The further process corresponds to the restart after a controlled stoppage, which was described above.

In the case of automatic start or startup of a rod maker according to the invention, the rod comes open out of the garniture belt 25, which is shown in FIG. 2. The garniture belt 25 is deflected here via a deflection roller 26. However, the rod 13 is not shown open in FIG. 2, but closed and in corresponding normal operation of the rod maker. Due to the open rod, it has to be transported through the transport nozzle 16 with the support of compressed air 24 through the transport nozzle 16, specifically here the compressed-air nozzles 237 and 238, and the rod cutter or cutting device 12. The open rod is drawn in by the transport rollers 19, 20. The further mode of operation corresponds to start and startup after a controlled stoppage.

A rod chopper can be provided downstream of the transport rollers 19, 20. The cooling strip 27 shown in FIG. 2 is used to set the adhesive coated seam on the wrapping material strip.

For cutting the rod, reference is made in particular to FIG. 2, which shows a diagrammatic sectional representation of part of a rod maker 10 according to the invention. The rod 13 is pulled by the transport rollers 19, 20 at a slight overspeed during the start. When the standard speed is reached the rod is closed and has reached a speed of, e.g., a maximum of 80 m/min. Shortly before the cut, the speed of the transport rollers 19, 20 is reduced with respect to the garniture belt 25, either to the same speed as the garniture belt or below this speed. The knife roller 14 and the cutter roller 15 are accelerated to rod speed. The rod is thereby lifted and straightened by the cutter roller 15. After the cut, the knife roller 14 and cutter roller 15 are braked within 180°.

In another variant of the procedure in the rod cutting according to FIG. 2 during startup the open filter rod 13 is moved through the transport nozzle 16 with the support of compressed air 24 from the compressed-air nozzles 237 and/or 238 and through the knife roller 14 and the cutter roller 15. To this end corresponding cut-outs 236, 236′ in the rollers 14, 15 are provided, which are discernible in FIG. 2 as non-shaded areas. The rod 13 is gathered by the transport rollers 19, 20, whereby the rod 13 is still conveyed in a “startup” 29 rod conveyor direction. The rod 13 is pulled at a slight overspeed compared to the speed of the rod in the garniture or the speed of the garniture belt 25. As soon as the rod is closed or at a time at which the rod is closed, the rod cutter or the cutting device 12 is accelerated to double rod speed and cuts the rod 13 into pieces. To this end the knife roller 14 and the cutter roller 15 are rotated in the direction of rotation shown accordingly about the rotation axes 234 or 24′. The cutting edge 233 of the knife 33 comes into operative engagement with the rod 13 and plunges a little into the groove 235 of the cutter roller 15.

The filter rods or the excess rod material is gathered and transported away by the transport rollers 19, 20. The rod 13 that comes from the cooling strip 27 is not bent. The rod is closed and has a speed of approx. a maximum of 80 m/min. After the last cut, the knife rollers 14 and the cutter roller 15 are braked within 180° and the correct rod is conveyed in the “operation” 28 rod conveyor direction.

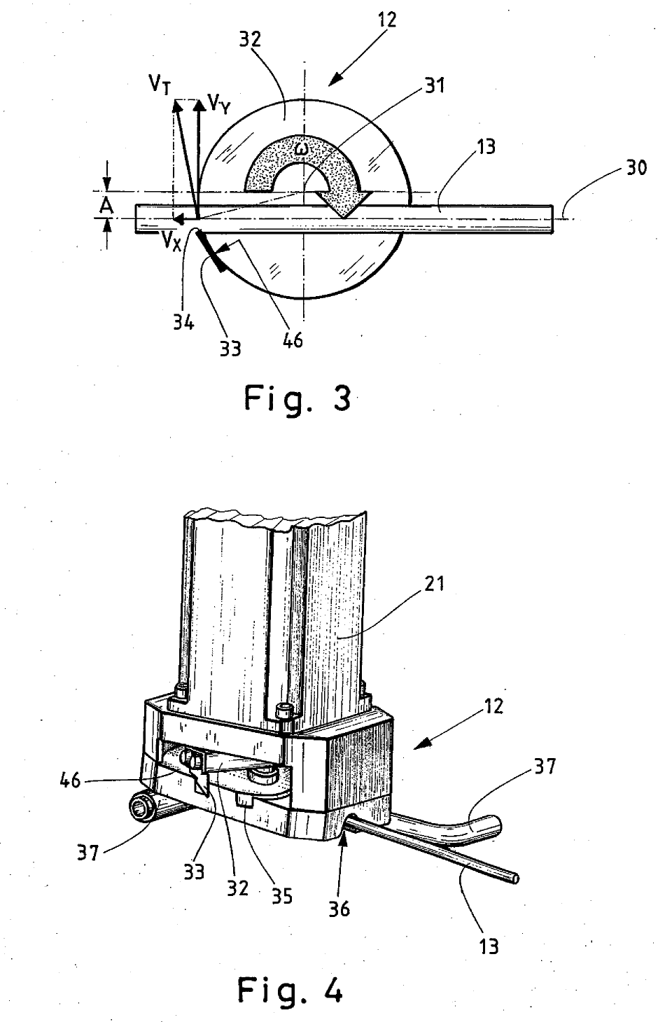

An alternative and particularly preferred cutting concept will now be explained in connection with FIGS. 3 and 4. FIG. 3 shows a diagrammatic representation of a cutting device 12 according to the invention. A knife 33 or a knife blade is mounted or arranged on a knife carrier 32 that turns in a plane inclined to the rod 13, namely in a direction of rotation that is indicated by ω in FIG. 3. Through the inclined plane, the knife 33 cuts the web of the rod 13 at only one point. The rod 13 runs, as shown in FIG. 4, through a groove opened at the bottom. However, the cutting device 12 can also be arranged so that the groove is not opened at the bottom, but at the side or the top. FIG. 4 shows the cutting device 12 according to the invention in a diagrammatic three-dimensional representation.

The rotation point or the rotation axis 31 is displaced by the measurement A from the rod axis 30 so that a component motion occurs in the rod conveyor direction according to the rod speed during the cut. This component motion is indicated by V_{X}. The actual motion is indicated by the vector V_{T}. The component motion crosswise to the rod conveyor direction is indicated by V_{Y}. Through an optimal design of the measurement A in relation to the rod speed and the motor speed or the rotational speed of the knife carrier ω, the compression to which the rod 13 is subjected during the cut can be reduced to a minimum. For example, the compression can be less than 1 mm.

The advantage of this arrangement is that a completely burst open rod cannot be piled up since it cannot hit any interfering edges. Moreover the rod 13 can easily be deflected downwards. The transport nozzle 16, which is shown in FIG. 2 and in FIG. 1, can be omitted. The structural expenditure for the cutting device is substantially reduced.

Moreover a cutter 34 of the knife 33 is indicated and furthermore a mounting point 46 of the knife 33 on the knife carrier 32. As shown in FIG. 3, the knife carrier can be in part rotationally symmetrical, however, it can also be a simple lever or arm. In the case of a lever or arm or also in the case of FIGS. 3 and 4 with a partially rotationally symmetrical body, it can be expedient to even out imbalances.

During production operation the lever 37 is swung clear and the knife 33 stands. The rod 13 runs through a groove 36 opened at the bottom. In the event of a burst rod, the rod is deflected downwards and can be caught by the transport rollers 19, 20, which are not shown in FIGS. 3 through 6 but are located in duct 48. In startup operation, namely when the rod is closed, the rotational speed of the traction or transport rollers 19, 20 is reduced and the lever 37 is pivoted upwards. The servo motor 21 for the knife carrier 32 accelerates in 300° to a very high rotational speed that is adjusted to the rod speed with the offset A. The cut occurs in the following 60°. Subsequently the motor is braked in 300° and slowly turned backwards into the starting position. Further, a circle segment-shaped groove or opening 35 can be provided to render possible a passage movement of the part of the cutting body 33 projecting beyond the first rotary body 32.

FIGS. 5 and 6 show part of a rod maker 10 according to the invention in a different embodiment in diagrammatic three-dimensional form. A cutting device 112 is hereby used in a different embodiment according to the invention. In the cases of FIGS. 5 and 6 the rotation axis of the circular knife 132 is horizontal in operation.

In FIG. 5 the entire cutting device 112, which is arranged on the lever arm 38, is swung upwards clear of the rod 13. The rod 13 is divided into a rod 13′ conveyed away and a rod 13″ that corresponds to a rod produced correctly and provided for further processing. Naturally, the two rod sections 13′ and 13″ cannot predominate simultaneously but only alternatively, whereby both partial rods or rods are shown for illustration purposes.

The rod 13′ reaches a duct 48. The rod 13″ produced correctly, which will be used in further processing, is guided to a measuring element 40, which can also be referred to as a measuring nozzle 40, and subsequently cut into corresponding filter elements (not shown). Furthermore, a cover 39 is provided in FIG. 5, which cover is pivoted downwards during operation. During operation the cutting device 112 is pivoted, towards the rod 13. To this end the lever arm 38 is moved downwards and moreover the lever arm 44, which is connected to the cutting device 112, is pivoted about the pivot axis 43. Furthermore, the lever 137 is pivoted to the rod via the pivot axis 42. The pivoting of the cutting device 112 is carried out horizontally via the pivoted arm 44′ so that a reliable approach to the rod 13 is rendered possible in order to provide an engagement of the knife with the rod.

The machine 10 has a device 11′ (device for removing rod material or device for carrying away rod material) for removing a rod section 13″ that is not free from defects from the measuring nozzle 40. The device 50 has three rolls 51, 52, 53, whereby the rolls 51, 52 are arranged on a first fork-shaped lever 54 and the roll 53 is arranged on a second lever. The axes of the rolls are essentially parallel to one another.

With an intentional or unintentional stoppage of the machine 10, a part of the rod 13″ remains stuck in the measuring nozzle 40 and prevents an automatic restart. For the removal, in particular automatic removal of this rod part, the levers 54 and 55 are moved such that the rolls 51, 52, 53 are lowered over the rod, whereby the rolls 51, 52 come to a stop before the rod and the roll 53 comes to a stop behind the rod. The roll 53 is then moved by the lever 55 towards the rolls 51, 52 and between them, whereby the rod part is gathered and pulled out of the measuring nozzle 40. Subsequently the roll 53 is moved back, releasing the rod part which falls into the duct 48. A sensor 250 can be provided to detect a burst rod and to generate a stop signal that starts an operating method according to the invention.

The machine 10 also has a different type of cutting device 112 for severing the rod 13. The cutting device 112 is composed essentially of a circular knife 132, which can have a corrugated or serrated blade, a lever 137 to support the rod 13 and a guide surface 150 to deflect the rod 13′ not produced correctly, in particular in FIG. 5, downwards into the duct 48.

To start up the machine, the rod 13′ is guided into the duct 48, this can be supported by air nozzles or conveyor rollers (not shown). As soon as the desired speed for inserting the rod into the measuring nozzle 40 has been reached, the cutting device 112 is swiveled into the area of the rod 13′, whereby the guide surface 150 first ensures that the rod 13′ does not come into contact with the knife 132. At this point the blade of the knife 132 lies behind the rod and the lever 137 lies before the rod. Before or behind the rod means relative to the viewpoint of the observer in FIG. 5 and 6. Subsequently the lever 137 is moved against the rod 13′ and the knife is moved in the opposite direction through the rod, which is thereby severed. The correct rod 13″ reaches the measuring nozzle 40 and passes through it due to its own rigidity. Subsequently the cutting device 112 is pivoted back out of the area of the rod 13″ in order to reduce the risk of a material jam in front of the measuring nozzle in the event of an undesired burst rod.

With a burst rod it can happen that filter material is drawn through the garniture belt 25 into the gap 151 between the garniture belt 25 and the transport nozzle 16 (FIG. 2) or a scraper 49 (FIG. 5, 6) and leads to a material jam there which would have to be removed manually. In order to prevent this, a compressed-air nozzle (not shown) can be arranged in the respective gap, which nozzle blows through the gap against the travel direction of the garniture belt in order to separate from the garniture belt any filter material resting thereon before it is drawn into the gap.

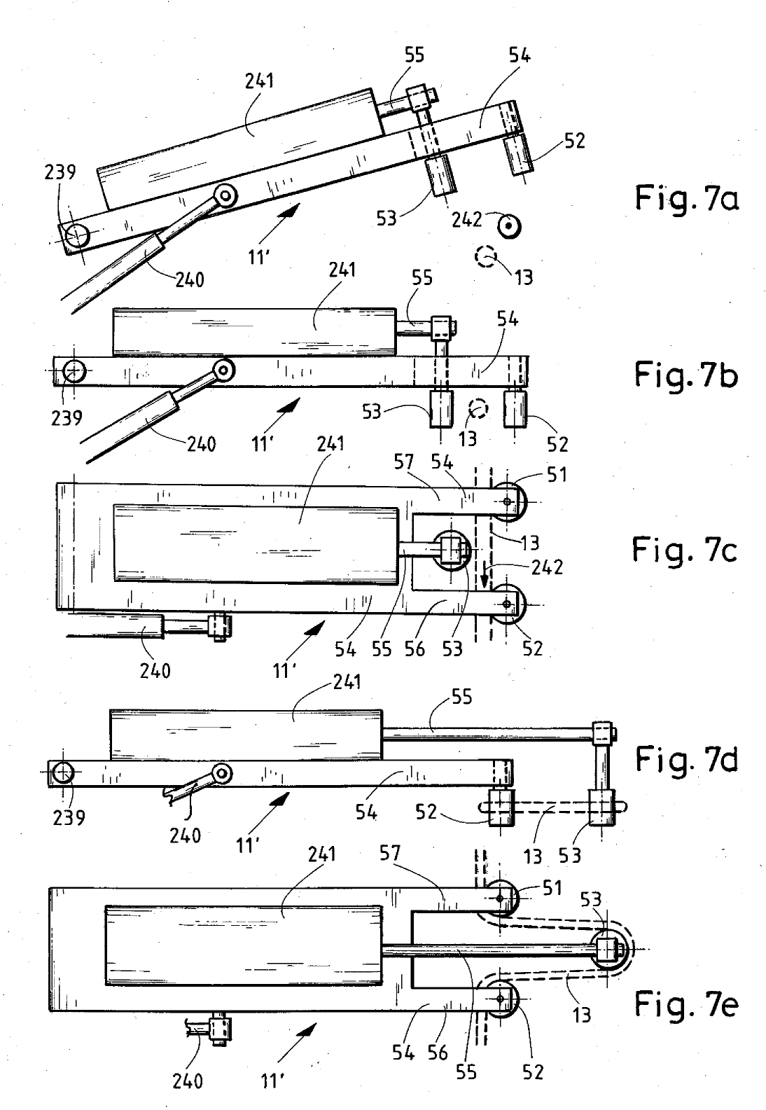

The mode of operation of the device 11′ for conveying away rod material is described in more detail based on FIGS. 7a through 7e. FIG. 7a shows a diagrammatic side representation of a device 11′ according to the invention for conveying away rod material in a position swung clear of the rod 13. The rolls 52 and 53 are discernible. The roll 52 is hinged on the lever 54 and thus firmly arranged relative to the lever 54 and the rotation axis 239 or pivot axis 239, but in a rotatable manner.

A linear drive 240 is provided in order to make it possible to swivel the device 11′ for conveying away rod material. The linear drive is attached to the lever 54. A linear drive 241 is arranged on the lever 54, from which drive a lever 55 projects that is connected to the roll 53. The lever 55 can be moved relative to the lever 54 in a translational linear manner so that, as shown below, the relative position of the roll 53 to the rolls 51 and 52 can change. FIG. 7a also shows diagrammatically the conveyor direction 242 of the rod 13. FIG. 7b shows the device according to the invention for conveying away rod material from FIG. 7a in a position swiveled towards the rod 13. A corresponding plan view to the representation from FIG. 7b is shown in diagrammatic representation in FIG. 7c The roll 51, which is hinged on the arm 57, and the roll 52, which is hinged on the arm 56, are also more clearly discernible in FIG. 7c If rod material or a part of a rod 13 is located in the machine and if an automatic clearing of this rod material is desirable, e.g., if the rod material is stuck in a measuring element 40, the lever 55 is moved by the linear drive 241 in a translational linear manner in the direction of the rod 13 and beyond. The movement also goes beyond an imaginary connecting line of the two rolls 51 and 52. Through this, as shown in FIGS. 7d and 7e, the rod material 13 is pulled away before the roll 51 and behind the roll 52 so that the rod material 13 can thus, e.g., be pulled out from the measuring element 40. Subsequently the lever 55 is moved back again in a linear translational manner so that the rod material 13 is released and can be removed.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### List of Reference Numbers

10 Filter rod maker

11, 11′ Device for conveying away rod material

12 Cutting device

13, 13′, 13 ″ Rod

14 Knife roller

15 Cutter roller

16 Transport nozzle

17 Servo motor

18 Synchronous belt drive

19 Transport roller

20 Transport roller

21 Servo motor

22 Spur-gear stage

23 Cover

24 Compressed air

25 Garniture belt

26 Deflection roller

27 Cooling strip

28 “Operation” rod conveyor direction

29 “Startup” rod conveyor direction

30 Longitudinal axis

31 Rotation axis

32 Knife carrier

33 Knife

34 Blade

35 Knife groove

36 Guide groove

37 Lever

38 Lever arm

39 Cover

40 Measuring element

42 Pivot axis

43 Pivot axis

44 Pivot arm

46 Mounting point

57 Garniture

48 Duct

49 Scraper

51 Roll

52 Roll

53 Roll

54 Lever

55 Lever

56 Arm

57 Arm

112 Cutting device

132 Circular knife

137 Lever

150 Guide surface

151 Gap

233 Cutting edge

234 Rotation axis

234′ Rotation axis

235 Groove

236,236′ Cut-out

237 Compressed-air nozzle

238 Compressed-air nozzle

239 Pivot axis

240 Linear drive

241 Linear drive

242 Rod conveyor direction

250 Sensor

250′ Sensor

What is claimed:

1. A rod-cutting device of the tobacco-processing industry comprising:
a rotatable cutting body with a cutting edge;
a first rotary body with a rotation axis on which the cutting body is arranged;
the cutting body being arranged essentially parallel to the rotation axis of the first rotary body, and having an extension at least from a mounting point to the cutting edge,
wherein a tangent of the first rotary body extends through or parallel to the extension.

2. The rod-cutting device according to claim 1, wherein at least a portion of the cutting body projects beyond the first rotary body in a longitudinal axial direction of the rotation axis.

3. The rod-cutting device according to claim 1, wherein the cutting edge is arranged essentially parallel to the rotation axis of the first rotary body.

4. The rod-cutting device according to claim 1, wherein the rotation axis of the first rotary body is spaced apart from a longitudinal axis of a rod to be cut.

5. The rod-cutting device according to claim 1, wherein the rotation axis of the first rotary body is non-perpendicularly oriented at an angle to a longitudinal axis of a rod to be cut.

6. The rod-cutting device according to claim 5, wherein the angle between the rotation axis of the first rotary body and the longitudinal axis is less than 90° to a downstream part of the rod, relative to a rod travel direction.

7. The rod-cutting device according to claim 1, further comprising a groove structured and arranged to guide a rod.

8. The rod-cutting device according to claim 2, further comprising a circle segment-shaped groove or opening structured and arranged to enable movement of the at least a portion of the cutting body projecting beyond the first rotary body.

9. A rod-cutting device of the tobacco-processing industry comprising:
a cutting body rotatable around a rotation axis; and
the cutting body having a knife,
wherein a cutting edge of the knife is arranged parallel to the rotation axis.

10. The rod-cutting device according to claim 9, wherein the knife is arranged to extend from the cutting body in a direction perpendicular to the rotation axis.

11. The rod-cutting device according to claim 9, wherein the cutting body comprises at least a part of a rotary body.

12. The rod-cutting device according to claim 9, further comprising a cutter roller structured and arranged to interact with the cutting body.

13. The rod-cutting device according to claim 12, wherein the cutter roller includes a groove structured to intermittently receive the knife during operation.

14. The rod-cutting device according to claim 12, wherein at least one of the cutting body and the cutter roller comprises one of a cut-out or flat portion.

15. The rod-cutting device according to claim 9, further comprising at least one compressed air nozzle arranged to direct compressed air against a rod during operation.

16. A rod-cutting device comprising:
a cutting body, movable in a rotating manner about a rotation axis, with a cutting edge;
wherein the rotation axis is oriented crosswise to a rod to be cut by the cutting body, and arranged essentially horizontally during operation of the rod cutting device.

17. The rod-cutting device according to claim 16, wherein the cutting body is pivotable to be swung clear of the rod.

18. The rod-cutting device according to claim 17, further comprising a rod guide pivotably arranged to be swung clear of the rod about a common pivot axis with the cutting body.

19. The rod-cutting device according to claim 16, further comprising a back support arranged upstream of the cutting device, relative to a rod travel direction, to support a cutting of the rod.

20. A device for conveying away rod material for a rod maker of the tobacco-processing industry, comprising:
two rotary bodies rotating in opposite directions and oriented to form a gap extending essentially in a rod travel direction;
wherein, during production operation, the two rotary bodies are arranged to draw rod material into the gap in order to convey the rod material away.

21. The device for conveying away rod material according to claim 20, wherein rotation axes of the two rotary bodies are essentially parallel.

22. The device for conveying away rod material according to claim 20, wherein the rotation axes of the two rotary bodies are arranged crosswise to the rod travel direction.

23. The device for conveying away rod material according to claim 20, wherein the two rotary bodies are pressure-loaded relative to one another.

24. The device for conveying away rod material according to claim 23, wherein one of the two rotary bodies-is spring-loaded against an other of the two rotary bodies.

25. The device for conveying away rod material according to claim 20, wherein at least one of the two rotary bodies is a transport roller.

26. The device for conveying away rod material according to claim 20, further comprising a rod material guide device located at least one of upstream and in an area of the two rotary bodies.

27. A device for conveying away rod material, comprising:
a first lever device and a second lever device,
wherein one of the first and second lever device is movable in a translational manner relative to an other of the first and second lever device.

28. The device for conveying away rod material according to claim 27, wherein the first and the second lever devices are pivotable about a common pivot axis that is essentially parallel to a rod conveyor device.

29. The device for conveying away rod material according to claim 27, wherein the second lever device comprises two arms.

30. The device for conveying away rod material according to claim 29, wherein the first lever device is arranged at least in part between the arms of the second lever device.

31. The device for conveying away rod material according to claim 27, wherein at least one of the first and second lever devices comprise a roll engagable with rod material.

32. A rod maker of the tobacco-processing industry comprising a cutting device according to claim 1.

33. A rod maker of the tobacco-processing industry comprising a device for conveying away rod material according to claim 22.

34. A method for operating a rod maker of the tobacco-processing industry, comprising:
forming a rod;
conveying the rod;
in an event of production interruption, automatically removing material remaining in the rod maker;
restarting the production process.

35. The method according to claim 34, wherein the production interruption is initiated by one of an operator or a sensor.

36. The method according to claim 34, wherein after the restart of the production process, the method further comprises separating startup wastage and feeding to a further processing step.

37. The method according to claim 34, wherein, when the production interruption comprises an opening of the rod, the method further comprises conveying the rod material away through a gap formed between two rotary bodies.

38. The method according to claim 34, wherein the automatic removing of material remaining in the rod maker is carried out by lever devices in order to gather, move and subsequently release the material.

39. The method for operating a rod maker of the tobacco-processing industry according to claim 34, further comprising:
conveying the rod material away through a gap forming between two rotary bodies;
forming a new rod upstream of the two rotary bodies;
cutting the new rod upstream of the two rotary bodies as soon as at least one of the new rod exhibits predetermined properties and a desired production speed has been reached;
conveying away a portion of new rod arranged downstream of the cutting; and
guiding a portion of the new rod arranged upstream of the cutting past the two rotary bodies for further processing.

40. The method according to claim 34, wherein a rotational speed of the two rotary bodies is at least at times greater than a conveyor speed of the new rod during the production of the new rod.

41. The method according to claim 40, wherein a greater speed is provided to the two rotary bodies as long as at least one of a predetermined property of the new rod has not attained and a predetermined rod conveyor speed has been achieved.
